(19) United States
(12) Patent Application Publication
(10) Pub. No.: US 2015/0246592 A1
(43) Pub. Date: Sep. 3, 2015

(54) EMERGENCY VEHICLE VENTILATION SYSTEM

(71) Applicant: Halcore Group, Inc., Grove City, OH (US)

(72) Inventor: Eric Fisher, Columbus, OH (US)

(21) Appl. No.: 14/635,769

(22) Filed: Mar. 2, 2015

Related U.S. Application Data
(60) Provisional application No. 61/947,123, filed on Mar. 3, 2014.

(51) Int. Cl. B60H 1/00

(52) U.S. Cl. CPC B60H 1/00507

(57) ABSTRACT

A service vehicle includes a vented compartment and a powered fan. The vented compartment presents an enclosed interior space and includes a compartment wall. The wall presents an exterior surface exposed to ambient air and an exterior vent opening that intersects the exterior surface. The powered fan fluidly communicates with the exterior vent opening.

### RELATED APPLICATION

This application claims the benefit of U.S. Provisional Application Ser. No. 61/947,123, filed Mar. 3, 2014, entitled EMERGENCY VEHICLE VENTILATION SYSTEM, which is hereby incorporated in its entirety by reference herein.

### BACKGROUND

1. Field

The present invention relates generally to vehicle compartments. More specifically, embodiments of the present invention concern a service vehicle with a vented compartment and a vent assembly mounted on the compartment.

2. Discussion of Prior Art

Prior art ambulances and other service vehicles with enclosed compartments generally have air venting systems to vent air from the compartment to a location exterior to the compartment (typically to ambient). For instance, conventional ambulances have a powered vent fan attached to the compartment to move a flow of exhaust air from within the compartment to the exterior location. The vent fan is customarily mounted to an upright side wall of the compartment.

However, prior art air venting systems for service vehicles have certain deficiencies. For instance, conventional venting systems are bulky and protrude excessively beyond an exterior and/or an interior surface of the side wall. Furthermore, conventional systems make it difficult to access and remove the vent fan from the vehicle (e.g., for repair or replacement of the vent fan).

### SUMMARY

The following brief summary is provided to indicate the nature of the subject matter disclosed herein. While certain aspects of the present invention are described below, the summary is not intended to limit the scope of the present invention.

Embodiments of the present invention provide a service vehicle that does not suffer from the problems and limitations of the prior art vehicles set forth above.

A first aspect of the present invention concerns a service vehicle that broadly includes a vented compartment and a powered fan. The vented compartment presents an enclosed interior space and includes a compartment wall. The wall presents an interior surface that at least partly encloses the interior space. The wall presents an exterior surface exposed to ambient air and an exterior vent opening that intersects the exterior surface. The powered fan fluidly communicates with ambient through the vent opening to transmit air between the interior space and ambient. The powered fan is mounted within the wall and is positioned between the interior and exterior surfaces so that the wall at least partly contains the powered fan.

A second aspect of the present invention concerns a service vehicle that broadly includes a vented compartment and a vent assembly. The vented compartment presents an enclosed interior space and includes a compartment wall. The wall presents an exterior surface exposed to ambient air and an exterior vent opening that intersects the exterior surface. The vent assembly includes a powered fan and an exterior vent cover attached to one another, with the powered fan fluidly communicating with the exterior vent opening. The exterior vent cover is mounted on the wall in engagement with the exterior surface to span the vent opening. The vent assembly is selectively removable from the wall, with the vent opening being sized to receive the powered fan and allow removal of the powered fan from the wall during vent assembly removal.

A third aspect of the present invention concerns a process of installing a powered vent assembly. The process broadly includes the steps of inserting a powered fan at least partly into a wall of a vented vehicle compartment through an exterior vent opening in an exterior surface of the wall; and covering the exterior vent opening with an exterior vent cover.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is an upper perspective of a service vehicle constructed in accordance with a preferred embodiment of the present invention, with the service vehicle including a wheeled chassis, a vented compartment mounted on the chassis, and forward and aft powered vent assemblies installed on the compartment;

FIG. 2 is a fragmentary interior perspective of the compartment shown in FIG. 1, showing a left side wall and roof of the compartment, with the compartment further including forward and aft interior covers mounted to the side wall to form plenums and pairs of vent tubes that fluidly connect the plenums to corresponding roof air ducts;

FIG. 3 is a fragmentary interior perspective of the compartment shown in FIGS. 1 and 2, showing an aft pair of vent tubes connected to an adapter plate of the aft interior cover and to the roof with circular adapters and fasteners;

FIG. 4 is a fragmentary exterior perspective of the compartment shown in FIGS. 1-3, showing the adapter plate of the aft interior cover, the aft pair of vent tubes, and the aft powered vent assembly exploded from the side wall and roof;

FIG. 5 is a fragmentary interior perspective of the compartment shown in FIGS. 1-4, showing the adapter plate of the aft interior cover, the aft pair of vent tubes, and the aft powered vent assembly exploded from the side wall and roof, with the interior cover presenting a generally rectangular opening;

FIG. 6 is a fragmentary cross section of the compartment shown in FIGS. 1-5, showing the path of exhaust air flow from within the compartment to a location exterior to the compartment, with the compartment including a false wall that covers the vent tubes and interior covers;

FIG. 7 is a fragmentary perspective of the aft powered vent assembly shown in FIGS. 1 and 4-6, showing an exterior vent cover, axial fan, gasket, and mounting plate of the powered vent assembly, with the exterior vent cover being cross-sectioned to show a chamber of the powered vent assembly;

FIG. 8 is a fragmentary perspective of the aft powered vent assembly similar to FIG. 7, but viewed from an opposite side of the powered vent assembly to depict the fan housing, electric motor, and axial fan impeller of the axial fan;

FIG. 9 is an exploded perspective of the aft powered vent assembly shown in FIGS. 1 and 4-8, with the exterior vent cover, axial fan, gasket, and mounting plate of the powered vent assembly being exploded apart from one another; and

FIG. 10 is an exploded perspective of the aft powered vent assembly similar to FIG. 9, but viewed from the opposite side of the powered vent assembly.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

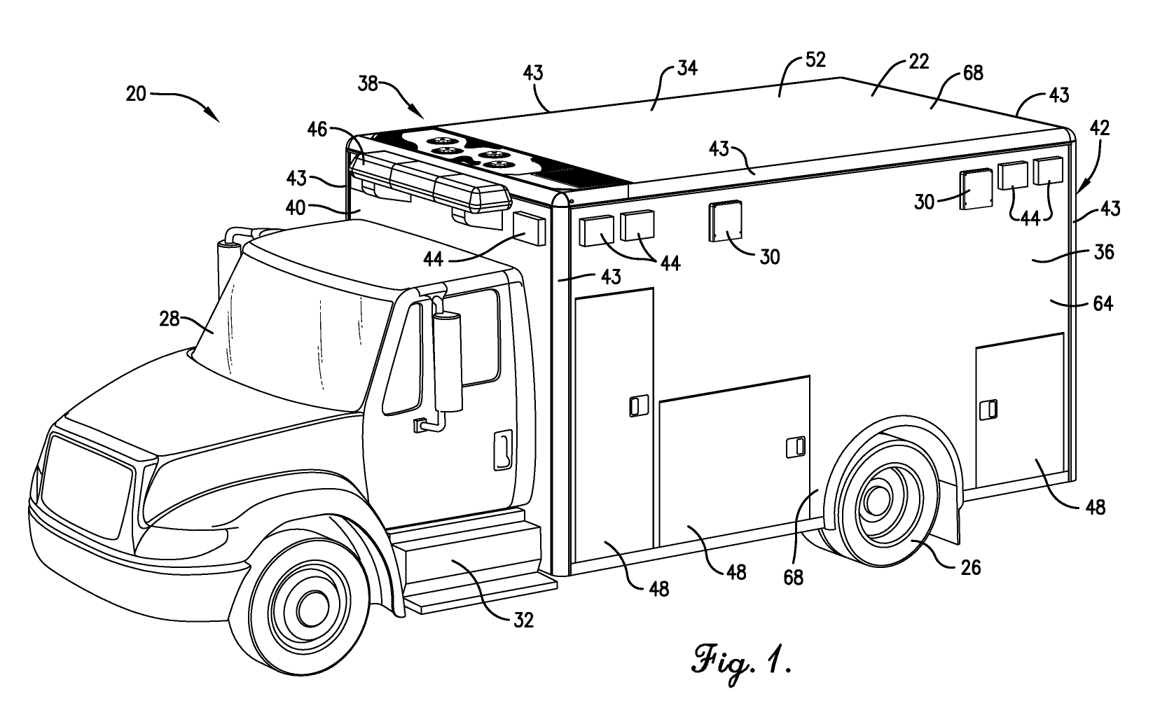

Turning initially to FIG. 1, a service vehicle 20 is constructed in accordance with a preferred embodiment of the present invention. As will be discussed further, the service vehicle 20 includes a vented compartment 22 that presents an enclosed interior space 24. The illustrated service vehicle 20 is preferably used as an emergency response vehicle, such as an ambulance. However, the principles of the present invention are applicable where the service vehicle 20, or various features thereof, are employed for other applications.

The service vehicle 20 preferably includes a wheeled chassis 26, a cab 28, the vented compartment 22, and powered vent assemblies 30. The wheeled chassis 26 and cab 28 are conventional and provided as part of a conventional powered truck 32. In the usual manner, the truck 32 is customized by mounting the vented compartment 22 to the frame (not shown) of the wheeled chassis 26 at a location aft of the cab 28.

The vented compartment 22 is sized and configured to receive one or more users within the interior space 24. For instance, when the service vehicle 20 is used as an ambulance, the illustrated vented compartment 22 is sized and configured to receive a patient (not shown) in a prone position along with one or more medical technicians (not shown). The vented compartment 22 preferably includes a roof 34, left and right side walls 36,38, and front and back end walls 40,42 that cooperatively enclose the interior space 24 and define an outer perimeter of the vented compartment 22. The walls 36,38,40,42 are interconnected with one another by elongated corner rails 43. In the usual manner, the vented compartment 22 is preferably constructed to be a rigid and self-supporting structure. The vented compartment 22 also preferably includes various warning lights 44,46 and exterior doors 48 attached to corresponding ones of the walls 36,38,40,42.

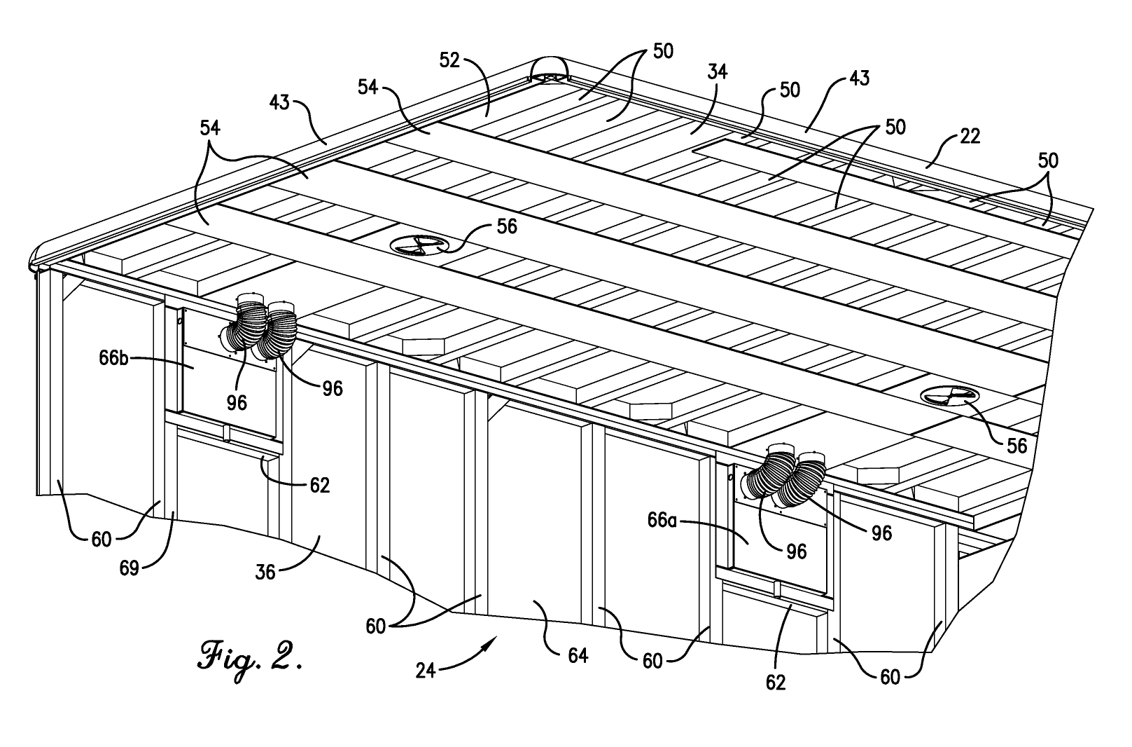

Turning to FIGS. 2-6, the roof 34 is conventional and preferably includes a plurality of laterally extending roof tubes 50, an outer skin 52, inner panels 54, and adjustable inlet vents 56. The roof tubes 50 each preferably comprise a structural tubular member that provides a support. The illustrated roof tubes 50 are preferably square metal tubes that are made of aluminum, but could include other materials without departing from the scope of the present invention. The roof tubes 50 extend laterally relative to and are spaced along the length of the service vehicle 20. The inner panels 54 preferably include a relatively thin sheet metal and insulation (not shown) that is removably attached to the roof tubes 50 using conventional fasteners. The outer skin 52 preferably includes a relatively thin metal sheet that is fixed to the roof tubes 50 using conventional fastening techniques. For instance, the skin 52 can be mounted by welding and/or fastening (e.g., using rivets) the skin 52 to the roof tubes 50.

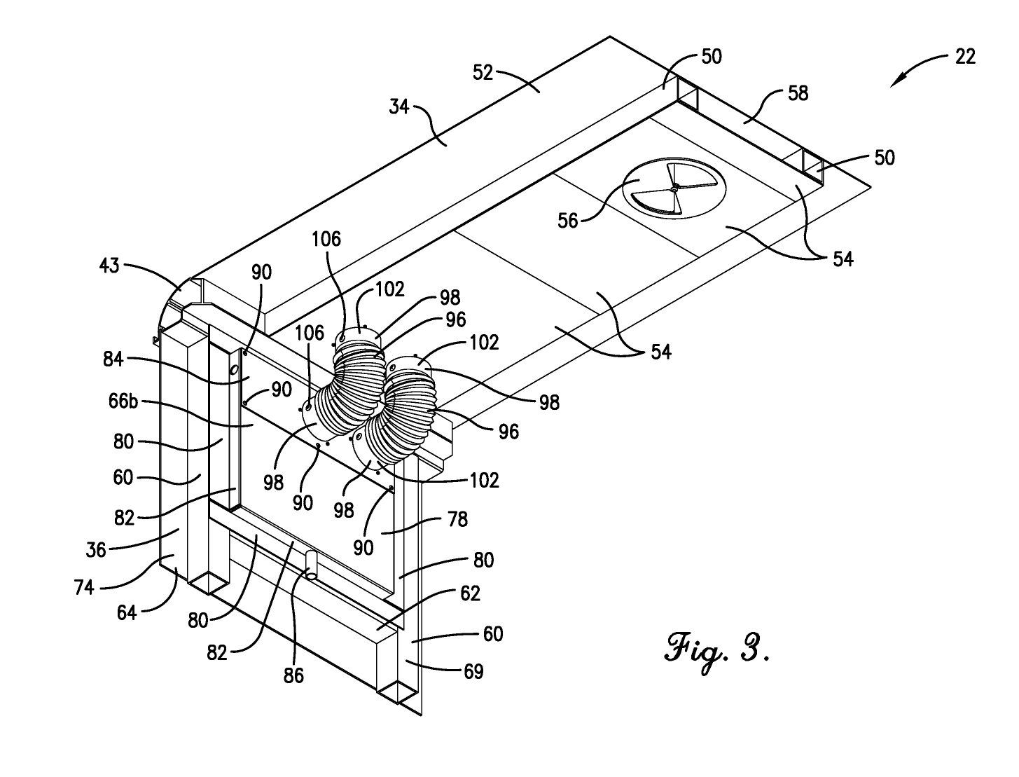

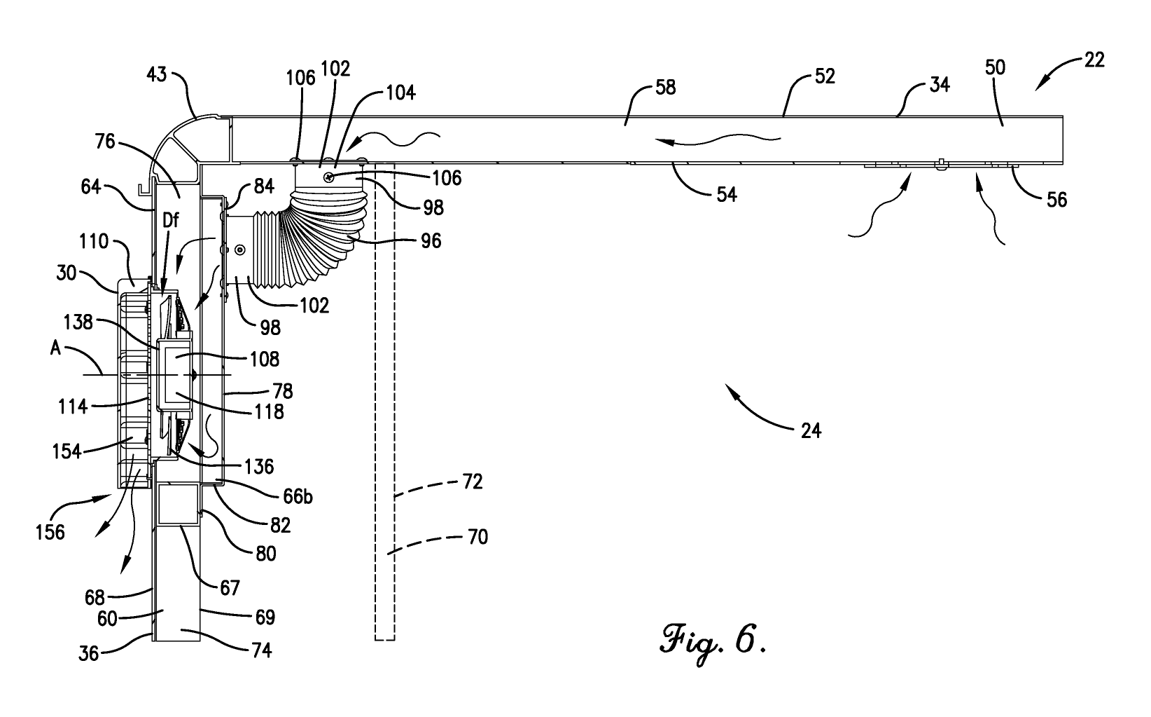

The outer skin 52, inner panels 54, and an adjacent pair of roof tubes 50 cooperatively form a roof air duct 58 (see FIGS. 3 and 6). The duct 58 is preferably in fluid communication with the inlet vent 56. The duct 58 is configured to transmit air between the interior space 24 and the ambient space outside of the compartment 22.

The side wall 36 is conventional and preferably includes a plurality of upright wall tubes 60, lateral wall tubes 62, an outer skin 64, and forward and aft interior covers 66a,b. The wall tubes 60,62 each preferably comprise a structural tubular member that provides a support. The illustrated wall tubes 60,62 are preferably square metal tubes that are made of aluminum, but could include other materials without departing from the scope of the present invention. The wall tubes 62 extend laterally relative to wall tubes 60 and are spaced along the length of the service vehicle 20.

The outer skin 64 preferably includes a relatively thin metal sheet that is fixed to the wall tubes 60,62 using conventional fastening techniques. For instance, the outer skin 64 can be mounted by welding and/or fastening (e.g., using rivets) the skin 64 to the wall tubes. 60,62 The side wall 36 preferably presents part of an exterior surface 68 of the compartment 22 (see FIG. 1). The wall tubes 60,62 of the side wall 36 preferably present an interior surface 69.

The vented compartment 22 also preferably includes false interior walls 70 (see FIG. 6) that extend along corresponding side walls 36,38 and end walls 40,42. The interior walls 70 cooperatively present part of an interior surface 72 that defines the interior space 24 of the compartment 22.

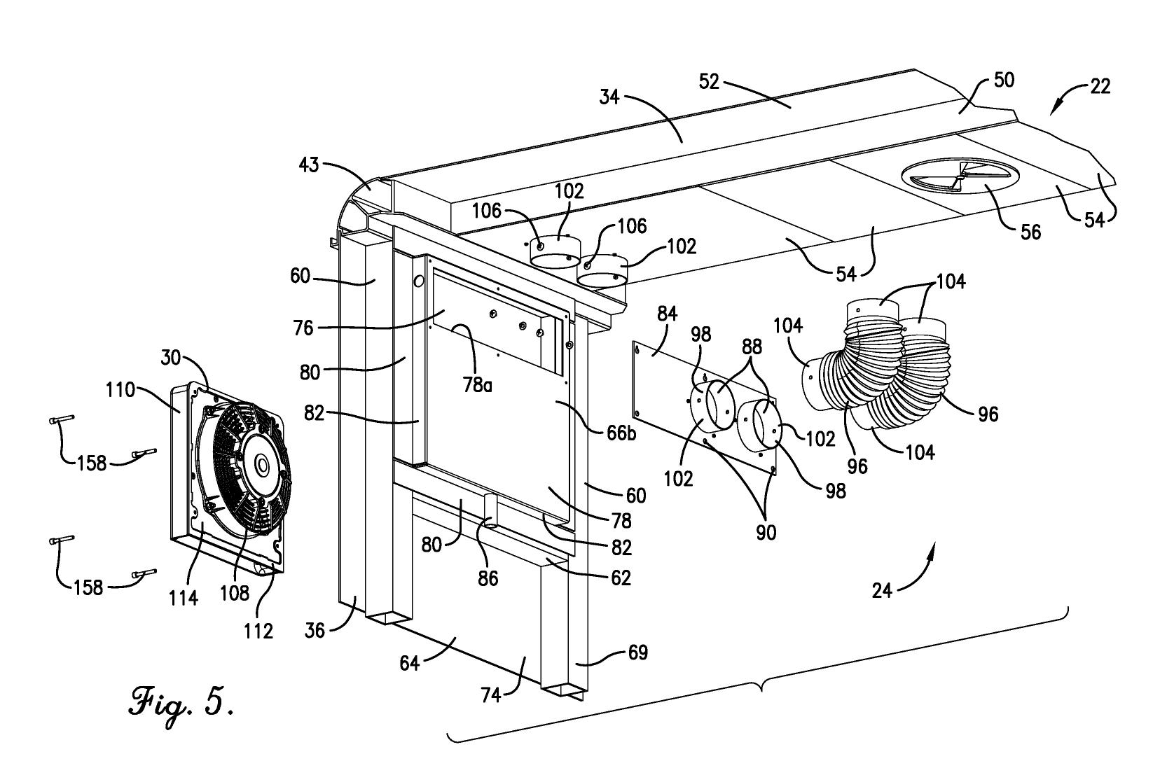

Turning to FIGS. 3-6, the interior covers 66a,b each preferably comprise a cover structure that spans an adjacent pair of upright wall tubes 60 to enclose part of a wall space 74 within the side wall 36. The interior covers 66 are preferably substantially identical to one another (with the only difference being that the adapter plates installed in different positions). The interior covers 66 and the side wall 36 cooperatively define plenums 76 to receive exhaust air (see FIG. 6). Each interior cover 66 preferably includes a central wall 78, an outer wall 80 that surrounds the central wall 78, and a rim 82 that interconnects the central wall 78 and the outer wall 80. The central wall 78 presents an opening 78a (see FIG. 5). Each interior cover 66 also preferably includes an adjustable adapter plate 84 and a drain tube 86 mounted in a lower part of the rim 82. The drain tube 86 is operable to receive any condensation within the plenum 76 and carry the condensation outside of the compartment 22.

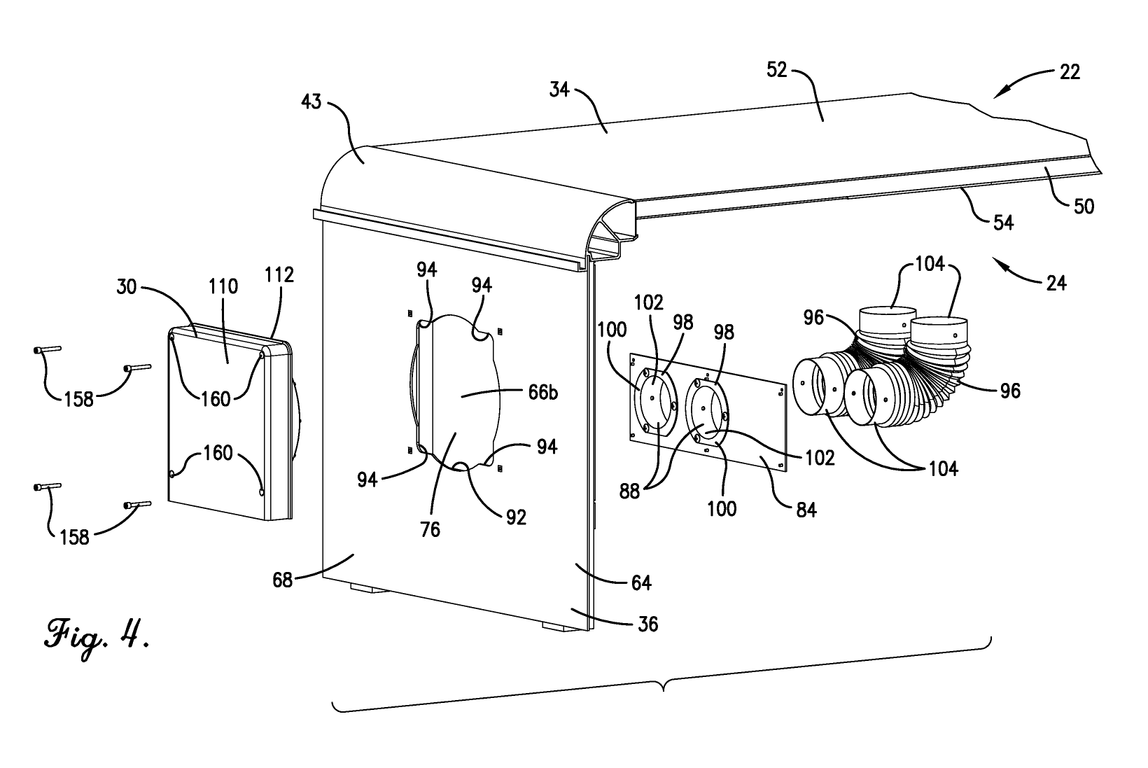

The illustrated adapter plate 84 preferably presents a pair of circular interior vent openings 88 (see FIG. 4) located alongside one another. The vent openings 88 are also preferably offset to one end of the adapter plate 84. However, it is within the scope of the present invention where the adapter plate 84 has one or more alternative vent openings 88. For instance, the vent openings 88 could be alternatively sized and/or shaped (e.g., to permit suitable venting of the compartment 22). While each of the illustrated covers 66 includes two vent openings 88, at least one of the interior covers 66 could be configured to include a single vent opening 88 or more than two vent openings 88.

The adapter plate 84 is removably attached to the central wall 78 with threaded fasteners 90 (see FIG. 3). The fasteners 90 can be used to secure the adapter plate 84 in one of two orientations relative to the central wall 78 (see FIG. 2). That is, the adapter plate 84 can be selectively mounted to the wall 78 to position the vent openings 88 in one of two locations relative to the wall 78. However, it will be appreciated that at least one of the interior covers 66 could be configured to provide more than two different arrangements of vent openings 88. Yet further, the vent openings 88 could have a fixed (i.e., nonadjustable) position on at least one of the interior covers 66.

Turning to FIGS. 4 and 6, the outer skin 64 preferably presents an exterior vent opening 92 that intersects the exterior surface 68 (see FIG. 4). The exterior vent opening 92 defines a generally circular shape, but also includes four scalloped edge sections 94. The exterior vent opening 92 is shaped and sized to removably receive the powered vent assembly 30, as will be discussed. The interior and exterior vent openings 88,92 are both in fluid communication with the plenum 76. Thus, the interior and exterior vent openings 88,92 and the plenum 76 cooperatively allow air to be vented from within the compartment 22 to ambient.

The vented compartment 22 also preferably includes curved vent tubes 96 and adapters 98 (see FIG. 2). Each adapter 98 preferably comprises a unitary and generally circular bracket and includes a flange 100 and a sleeve 102 integrally formed with one another. Each vent tube 96 preferably comprises a flexible tube that is elongated and presents opposite tube ends 104. The illustrated vent tube 96 is a three inch (3″) diameter flexible duct, Model No. 02841000, supplied by Pro Air Supply. However, the vent tubes 96 could be alternatively shaped and/or configured without departing from the scope of the present invention. For instance, each vent tube 96 could comprise a substantially rigid tube.

Each end 104 of the vent tube 96 is attached to a corresponding one of the adapters 98 with threaded fasteners 106 (see FIG. 3). In particular, each tube end 104 slidably receives a sleeve 102 of a corresponding adapter 98. The vent tubes 96 are fluidly connected to corresponding interior vent openings 88 by attaching the respective adapters 98 to the adapter plate 84 with fasteners 106. Similarly, the vent tubes 96 are fluidly connected to the roof air duct 58 by attaching the respective adapters 98 to the roof 34 with fasteners 106 (see FIG. 6). Thus, the vent tubes 96 are configured to transfer air from the roof air duct 58 to the plenum 76 (see FIG. 6).

Turning to FIGS. 4-10, each of the powered vent assemblies 30 preferably serves to induce a venting air flow from within the interior space 24 of the compartment 22 to ambient. However, the principles of the present invention are applicable where the vent assemblies 30 induce air flow in the opposite direction (i.e., by inducing air flow from ambient to the interior space 24 of the compartment 22). While the vent assemblies 30 are preferably identical to one another, it is within the scope of the present invention where the vent assemblies 30 have different constructions. Each of the illustrated vent assemblies 30 preferably includes a powered axial fan 108, an exterior vent cover 110, a gasket 112, and a mounting plate 114.

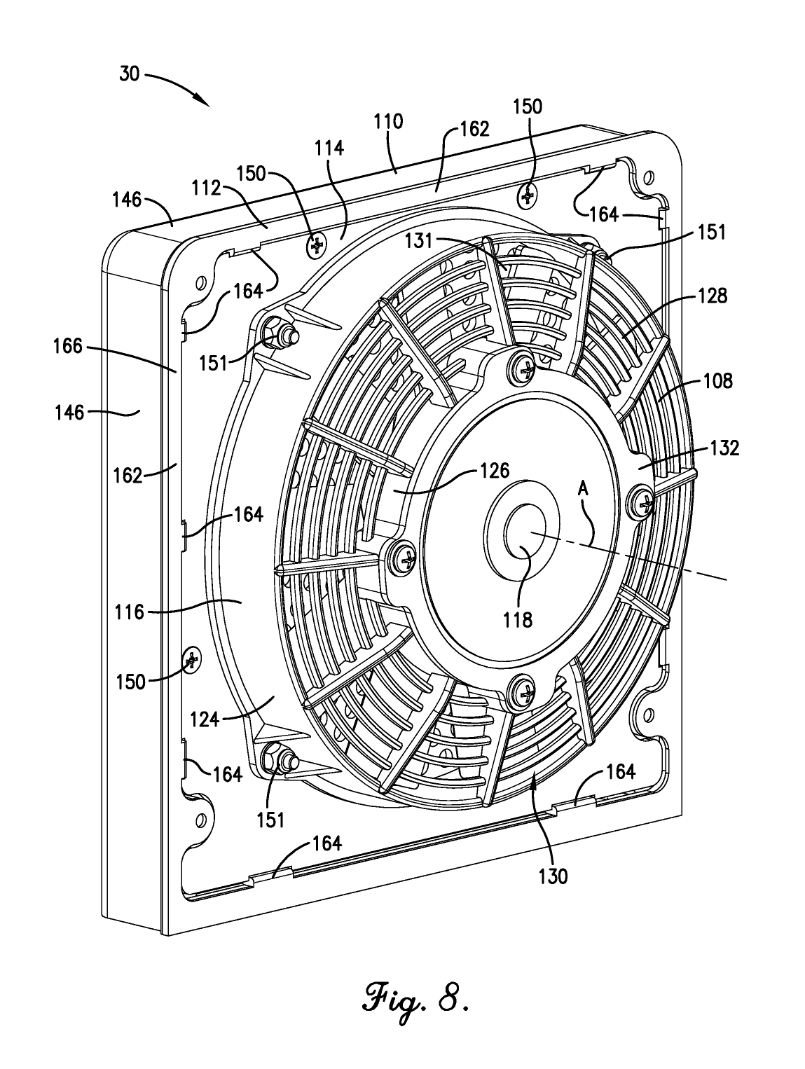

Turning to FIGS. 8-10, the powered axial fan 108 is conventional and includes a fan housing 116, an electric motor 118 mounted within the housing 116, a power cord (not shown), and an axial fan impeller 122. The fan housing 116 includes a cylindrical outer wall 124, an inner wall 126, and an annular grille 128 that extends radially between the walls 124,126 to present an inlet opening 130 (see FIG. 8). The outer and inner walls 124,126 cooperatively define an axially extending passage 131. The electric motor 118 includes a motor housing 132 and a rotatable shaft (not shown), with the motor 118 being mounted to the inner wall 126.

The axial fan impeller 122 includes multiple fan blades 136 and a hub 138, with the blades 136 mounted on and spaced about the hub 138. The hub 138 is mounted on the shaft and is sized to at least partly receive and extend about the motor housing 132 (see FIG. 6). Thus, the axial fan impeller 122 is at least partly coextensive with the motor housing 132 and with the fan housing 116 along a rotational axis A of the motor 118. The illustrated axial fan 108 is sometimes referred to as a pancake fan. With the described configuration, the powered axial fan 108 preferably presents a relatively compact axial dimension suitable for installation within the side wall 36. The axial fan 108 preferably comprises an automotive 12 Volt fan, Model No. VA14-AP11/C-34, Manufactured by SPAL Automotive.

The axial fan impeller 122 is preferably rotatably mounted and driven by the motor 118 to move air along the length of the passage 131. More preferably, the axial fan impeller 122 is positioned so as to be at least partly received by the passage 131. However, the axial fan impeller 122 could be alternatively positioned.

The axial fan 108 is preferably sized to move air at a volumetric flow rate ranging from about three hundred cubic feet per minute (300 cfm) to about five hundred cubic feet per minute (500 cfm) and, more preferably, moves air as a flow rate of about four hundred cubic feet per minute (400 cfm). The axial fan impeller 122 presents an outermost fan diameter dimension Df (see FIG. 6) that ranges preferably from about five inches (5″) to about ten inches (10″).

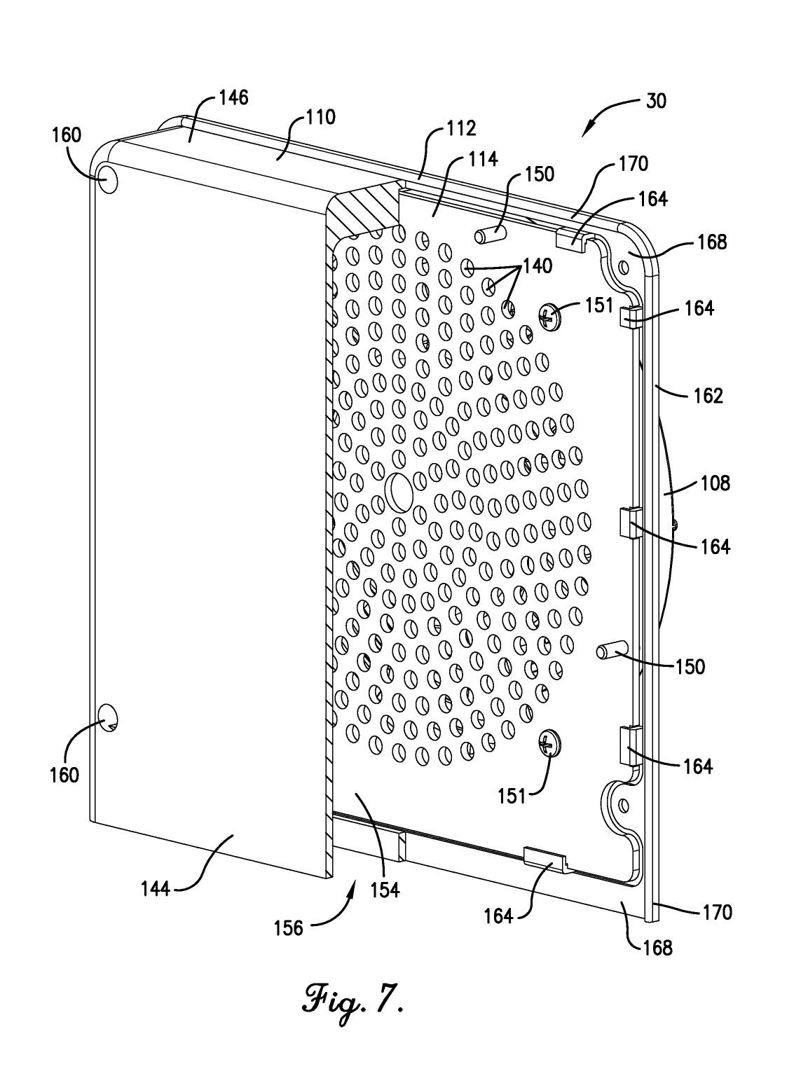

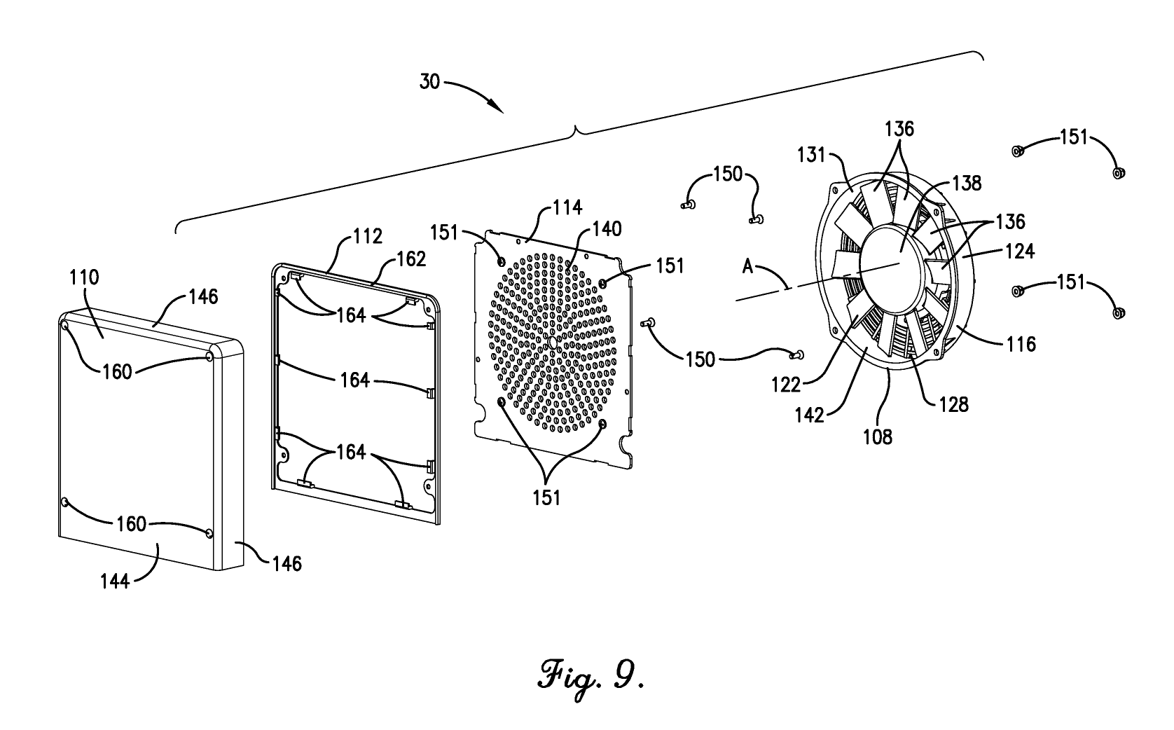

Turning to FIGS. 7-10, the mounting plate 114 is preferably configured for mounting the axial fan 108 to the exterior vent cover 110 (see FIGS. 7, 9, and 10). The mounting plate 114 preferably comprises a flat, stainless steel plate that includes a plurality of perforations 140. The mounting plate 114 is secured to the fan housing 116 to overlie an outlet opening 142 of the fan housing 116 (see FIG. 9). Thus, the mounting plate 114 is configured to restrict access to the motor 118 and the impeller 122. However, the perforations 140 are sized and configured to allowed air flow to pass through the axial fan 108.

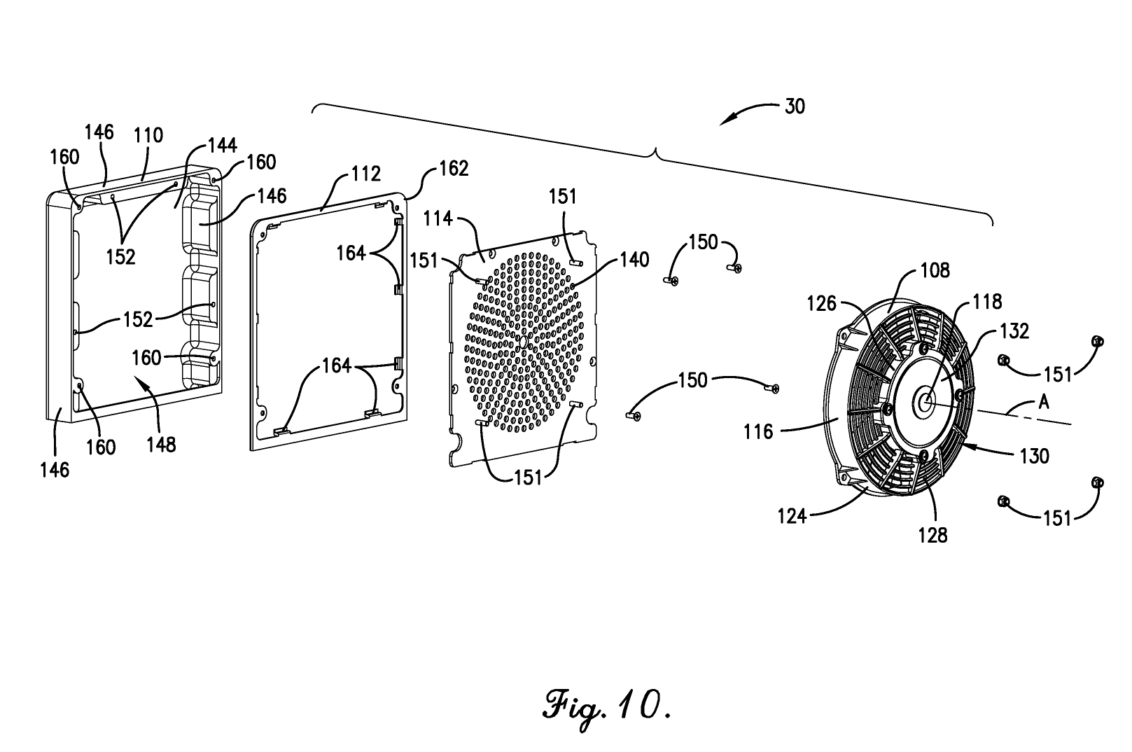

The exterior vent cover 110 provides a convenient and compact structure to direct venting air flow out of the compartment 22. The vent cover 110 preferably includes a cover section 144 and three (3) side sections 146 that extend along an outer margin of the cover section 144 to present an open face 148 (see FIG. 10). The illustrated cover section 144 and side sections 146 are preferably formed by a unitary, cast aluminum structure. However, the principles of the present invention are applicable where the vent cover 110 includes alternative features and/or materials.

The vent cover 110 is preferably removably attached to the mounting plate 114 and the fan housing 116 with threaded fasteners 150,151 to support the mounting plate 114 and fan housing 116 relative to the side wall 36. The mounting plate 114 engages the side sections 146 and spans the open face 148. The fasteners 150 extend through the mounting plate 114 and into threaded openings 152 presented by the vent cover 110 (see FIG. 10). When attached to one another, the mounting plate 114 and vent cover 110 cooperatively present a covered chamber 154 and a generally rectangular discharge opening 156 (see FIG. 7). The chamber 154 permits venting air to pass from the perforations 140 to the discharge opening 156.

While the illustrated vent cover 110 preferably supports the mounting plate 114 and the fan housing 116 when the vent assembly 30 is installed, at least one of the vent assemblies 30 could be alternatively configured. For instance, the vent cover 110 and mounting plate 114 could each be independently mounted on the side wall 36 and could be separately attached and detached from the side wall 36.

Turning to FIGS. 4-6, when assembled, the exterior vent cover 110, axial fan 108, and mounting plate 114 of the vent assembly 30 are preferably movable as a unitary structure. Furthermore, the vent assemblies 30 are preferably installed in the compartment 22 and removed therefrom as a unitary structure. However, it is within the ambit of the present invention where components of at least one of the vent assemblies 30 are separately installed and/or removed. As will be shown, the illustrated vent assembly construction permits convenient installation and removal of the vent assemblies 30 relative to the compartment 22.

The vent assemblies 30 are preferably removably attached to the side wall 36 with threaded fasteners 158. In particular, the vent assemblies 30 are preferably positioned so that the axial fan 108 projects into the plenum 76 and the exterior vent cover 110 spans the exterior vent opening 92. The vent assemblies 30 are also positioned so that the discharge opening 156 faces downwardly. The fasteners 158 extend through corresponding holes 160 in the vent cover 110 and are threaded into the side wall 36.

Turning to FIGS. 4-10, the gasket 112 extends along and is mounted between the side sections 146 and the exterior surface 68 to form a seal therebetween. The gasket 112 preferably comprises a unitary structure and includes an endless gasket body 162 and clips 164 fixed to the gasket body 162. The gasket 112 also presents opposite sealing faces including a flat seal face 166 and a recessed seal face 168 surrounded by a peripheral bead 170 that projects laterally from the seal face 168 (see FIGS. 7 and 8). In the usual manner, the gasket body 162 preferably includes an elastomeric material so that the gasket body 162 can be elastically compressed. However, it is within the ambit of the present invention where the gasket 112 is alternatively configured. For instance, the gasket body 162 could present ends of the gasket 112 (e.g., where the ends are spaced apart from one another).

The powered axial fan 108 is preferably located between the interior and exterior surfaces 68,69 and is positioned within the side wall 36. In particular, the powered axial fan 108 is preferably mounted on the side wall 36 so that the side wall 36 contains the motor 118 and the fan impeller 122 of the axial fan 108. However, for some aspects of the invention, the motor 118 and/or the fan impeller 122 could project at least partly out of the side wall 36. For instance, the motor 118 and/or the fan impeller 122 could project outwardly beyond the exterior surface 68 of the side wall 36 and/or inwardly beyond the interior surface 69 of the side wall 36.

While the illustrated vehicle 20 only includes two vent assemblies 30, it will be appreciated that the vehicle 20 could include a single vent assembly 30 or more than two vent assemblies 30 (e.g., to cooperatively provide a sufficient flow rate of venting air flow).

To secure the vent assemblies 30 to the compartment 22, the vent assemblies 30 are preferably first assembled. As discussed above, the axial fan 108 is secured to the mounting plate 114 with threaded fasteners and the vent cover 110 is secured to the mounting plate 114 with threaded fasteners. Once assembled, each vent assembly 30 is positioned by inserting the axial fan 108 through the exterior vent opening 92 and into the wall space 74. The vent assembly 30 is inserted in an inboard direction until the side sections 146 and the outer skin 64 of the side wall 36 cooperatively engage the gasket 112. The vent cover 110 is mounted on the side wall 36 in engagement with the gasket 112 and spans the exterior vent opening 92. In the illustrated embodiment, the vent cover 110 preferably covers the exterior vent opening 92. The vent cover 110 also preferably spans the diameter of the passage 131. The vent assembly 30 is preferably secured by arranging the discharge opening 156 in the downwardly-facing position. However, the discharge opening 156 could be alternatively positioned. The vent cover 110 is then attached to the side wall 36 with threaded fasteners.

While each vent assembly 30 is preferably fully assembled prior to installation (to permit installation as a unit), it is within the scope of the present invention for components of the vent assembly 30 to be installed separately from one another. For instance, as discussed above, the mounting plate 114 could be attached directly to the side wall 36 independently of the vent cover 110. Thus, each vent assembly 30 could be installed by first attaching the mounting plate 114 and axial fan 108 to the side wall 36 and then attaching the vent cover 110 to the side wall 36 over the mounting plate 114 and axial fan 108.

Each vent assembly 30 can be selectively removed from the side wall 36 of the compartment 22 by initially removing the threaded fasteners. With the fasteners removed, the entire vent assembly 30 can be moved in an outboard direction as a single unit, with the axial fan 108 being passed through the exterior vent opening 92. Once the vent assembly 30 is removed entirely from the wall space 74 of the side wall 36, the axial fan 108 can be selectively detached from the mounting plate 114. For instance, the axial fan 108 can be detached from the mounting plate 114 so that the axial fan 108 can be repaired. The axial fan 108 and mounting plate 114 can also be detached to allow a replacement axial fan 108 to be attached to the mounting plate 114. The replacement axial fan 108 can then be installed with the mounting plate 114 and the vent cover 110 on the side wall 36 by inserting the replacement axial fan 108 through the exterior vent opening 92 and into the wall space 74 of the side wall 36.

Each vent assembly 30 is preferably fully assembled when removed and is removed as a unit from the compartment. However, it is within the scope of the present invention for components of the vent assembly 30 to be removed separately from one another. For instance, where the mounting plate 114 is attached directly to the side wall 36 independently of the vent cover 110, the vent cover 110 could be independently removed from the side wall 36 to expose the exterior vent opening 92 (i.e., while the mounting plate 114 and axial fan 108 remain installed). The mounting plate 114 and axial fan 108 could then be selectively removed from the side wall 36 through the exterior vent opening 92.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A service vehicle comprising:
a vented compartment presenting an enclosed interior space and including a compartment wall,
said wall presenting an interior surface that at least partly encloses the interior space,
said wall presenting an exterior surface exposed to ambient air and an exterior vent opening that intersects the exterior surface; and
a powered fan fluidly communicating with ambient through the vent opening to transmit air between the interior space and ambient,
said powered fan mounted within the wall and positioned between the interior and exterior surfaces so that the wall at least partly contains the powered fan.

2. The service vehicle as claimed in claim 1; and
a vent assembly including an exterior vent cover and the powered fan,
said exterior vent cover being mounted on the wall in engagement with the exterior surface to span the vent opening.

3. The service vehicle as claimed in claim 2,
said exterior vent cover and said powered fan being attached to one another, said vent assembly being selectively removable from the wall, with the vent opening being sized to receive the powered fan and allow removal of the powered fan from the wall during vent assembly removal.

4. The service vehicle as claimed in claim 1,
said powered fan comprising a powered axial fan.

5. The service vehicle as claimed in claim 4,
said powered axial fan comprising a pancake fan.

6. The service vehicle as claimed in claim 4,
said powered axial fan being sized to move air at a volumetric flow rate ranging from about 300 cubic feet per minute to about 500 cubic feet per minute.

7. The service vehicle as claimed in claim 4,
said powered axial fan including an axial fan housing and an axial fan impeller, said axial fan housing presenting an axially extending passage, said axial fan impeller being rotatably mounted in the axial fan housing and at least partly received by the passage to move air along the length of the passage.

8. The service vehicle as claimed in claim 7; and
a vent assembly including an exterior vent cover and the powered fan, said exterior vent cover attached to the axial fan housing and spanning a transverse dimension of the axial passage.

9. The service vehicle as claimed in claim 7,
said axial fan impeller presenting a fan diameter dimension ranging from about five inches to about ten inches.

10. The service vehicle as claimed in claim 4,
said powered fan configured to transmit air from the interior space to ambient.

11. The service vehicle as claimed in claim 1,
said powered fan located between the interior and exterior surfaces and thereby positioned within the wall.

12. A service vehicle comprising:
a vented compartment presenting an enclosed interior space and including a compartment wall,
said wall presenting an exterior surface exposed to ambient air and an exterior vent opening that intersects the exterior surface; and
a vent assembly including a powered fan and an exterior vent cover attached to one another, with the powered fan fluidly communicating with the exterior vent opening,
said exterior vent cover being mounted on the wall in engagement with the exterior surface to span the vent opening,
said vent assembly being selectively removable from the wall, with the vent opening being sized to receive the powered fan and allow removal of the powered fan from the wall during vent assembly removal.

13. The service vehicle as claimed in claim 12,
said powered fan comprising a powered axial fan.

14. The service vehicle as claimed in claim 13,
said axial fan comprising a pancake fan.

15. The service vehicle as claimed in claim 13,
said powered axial fan including an axial fan housing and an axial fan impeller, said axial fan housing presenting an axially extending passage, said axial fan impeller being rotatably mounted in the axial fan housing and at least partly received by the passage to move air along the length of the passage.

16. The service vehicle as claimed in claim 15; and
a vent assembly including an exterior vent cover and the powered fan, said exterior vent cover attached to the axial fan housing and spanning a transverse dimension of the axial passage.

17. The service vehicle as claimed in claim 15; and
an exterior vent cover attached to the axial fan housing and spanning a transverse dimension of the axial passage.

18. A process of installing a powered vent assembly, said process comprising the steps of:
a) inserting a powered fan at least partly into a wall of a vented vehicle compartment through an exterior vent opening in an exterior surface of the wall; and
b) covering the exterior vent opening with an exterior vent cover.

19. The process as claimed in claim 18,
wherein the exterior cover is coupled to the powered fan during said inserting of step a).

20. The process as claimed in claim 18,
further comprising
i) removing the exterior vent cover from the wall of the vented compartment, thereby exposing the exterior vent opening, and
ii) simultaneously with or subsequent to step i), removing the powered fan from the wall through the exterior vent opening.

21. The process as claimed in claim 20,
wherein steps i) and ii) are carried out simultaneously, with the powered fan being coupled to the vent cover.

22. The process as claimed in claim 21,
further comprising, subsequent to step b), decoupling the powered fan from the vent cover.

23. The process as claimed in claim 20,
further comprising, subsequent to steps i) and ii), inserting a replacement fan into the wall through the exterior vent opening and covering the exterior vent opening with the exterior vent cover.

24. The process as claimed in claim 23,
further comprising decoupling the powered fan from the exterior vent cover and coupling the replacement fan to the exterior vent cover.
